(19) United States
(12) Patent Application Publication
(10) Pub. No.: US 2009/0063448 A1
(43) Pub. Date: Mar. 5, 2009

(54) Aggregated Search Results for Local and Remote Services

(75) Inventors: Adam DePue, Redmond, WA (US); Paul Fitzgerald, Woodinville, WA (US); Jonathan A. Hoover, Kirkland, WA (US); Sean Daniel, Redmond, WA (US); Dean Paron, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/846,621

(22) Filed: Aug. 29, 2007

(51) Int. Cl. G06F 17/40; G06F 17/30

(52) U.S. Cl. 707/5; 707/E17.014

(57) ABSTRACT

A search system may include searches performed on remotely hosted services that may be indexed and queried by an aggregated search tool. The search tool may aggregate desktop searches and internet searches with searches of remotely hosted services into a single set of results. Remotely hosted services may include databases and other services that are hosted over the Internet but may be privately available to a user. Examples of remotely hosted services may include shared directories, customer resource management systems, project management tools, accounting systems, and other remote services. In some embodiments, a search index created from the remote service may be stored locally or on a server.

### BACKGROUND

Searching computer data for useful information is one of the most important functions of today's computer systems. In addition to Internet search engines that may search websites and other publically accessible data, various applications such as email programs, word processing programs, spreadsheets, and other sources may generate large amounts of data that may be stored locally on a computer system.

From a user's standpoint, useful data may be spread across many formats, such as email, spreadsheets, websites, and other databases. When performing a search, a user may wish to perform a search for specific keywords or content without knowing exactly which type of content may be returned. For example, a search for a specific airline may return the airline's website but also email confirmation of a recent trip on the same airline.

### SUMMARY

A search system may include searches performed on remotely hosted services that may be indexed and queried by an aggregated search tool. The search tool may aggregate desktop searches and internet searches with searches of remotely hosted services into a single set of results. Remotely hosted services may include databases and other services that are hosted over the Internet but may be privately available to a user. Examples of remotely hosted services may include shared directories, customer resource management systems, project management tools, accounting systems, and other remote services or remotely hosted applications. In some embodiments, a search index created from the remote service may be stored locally or on a server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with searching capabilities for remote services.

FIG. 2 is a flowchart illustration of an embodiment showing a method for searching multiple data stores and aggregating results.

### DETAILED DESCRIPTION

Remote services may be included into a multifaceted search system that may also perform desktop searches and local area network searches. The remote services may be indexed with an index stored on a local area network server, remote server, or on a client device. The search system may receive a search request, perform queries using various indexes, including the index from the remote service, and aggregate the results from the various sources using various aggregation techniques.

Remote services may be any type of service that is accessed over a network connection, including services provided over the Internet. Such services may involve access to specialized databases, remote file storage system, or other information. In many cases, the service may restrict general access to the data and may use authentication or other access control to allow only registered users to access the data.

The search system may use a crawler or other indexing mechanism to generate an index of the remote service for the data for which the user has permission to access. The index may be stored on a user's client device, a local server, a remote server, a server that hosts the remote service, or other location.

When a search is initiated, the index of the remote service may be queried and results returned. The results may be aggregated with other search results, such as desktop search results, local area network search results, internet search results, and other search results.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

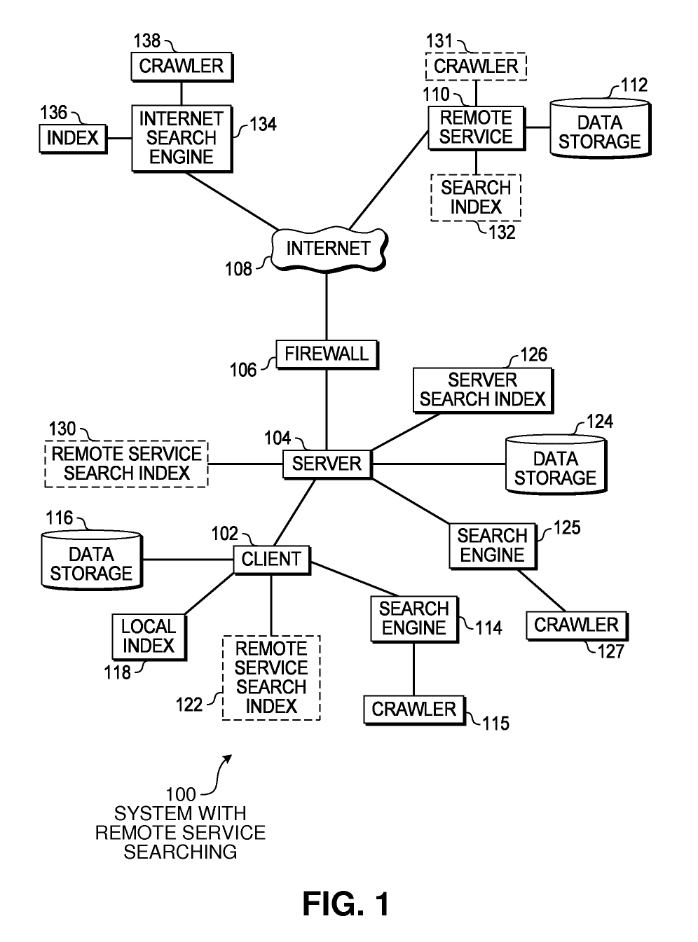

FIG. 1 is a diagram of an embodiment 100 showing a system for searching that includes remote services. The embodiment 100 is one mechanism by which data that is available through a remote service may be searched and included in an aggregated search that may also include search results from other data stores.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the various components described.

The components that make up the embodiment 100 include a client device 102 that may connect to a server 104. The client 102 may have access through a firewall 106 and the internet 108 to a remote service 110. The remote service 110 may have a data storage system 112.

The various components are typical of a computer network that may be found in a business environment. The client device 102 may be a personal computer, personal digital assistant, data enabled cellular telephone, network appliance, or any other computing device attached to a network.

The client device 102 may have a local search engine 114 that may perform aggregated searches of indexed data stores across the server 104, the remote service 110, and may incorporate results from an internet search engine 134. In some cases, the local search engine 114 may perform a desktop search that includes searches of a local data store 116 using a local index 118.

The local search engine 114 may have a crawler 115 that may be adapted to create the local index 118, as well as other indexes. The crawler 115 may traverse a file system or data structure of the local data store 116 to create the local index 118.

In some cases, the client 102 may have an index 122 for the remote service database 112. The client crawler 115 may traverse the data structure of the remote data store 112 to create the remote service search index 122 that is stored on the client device 102.

The server 104 may be a server on a local area network with respect to the client 102 and may contain a data storage system 124. In some embodiments, a search engine 125 may operate on the server 104 to provide searching capabilities across the server data storage system 124 using a server search index 126. In some embodiments, the server search engine 125 may also perform a search of the remote service data storage 112 using a remote service search index 130 that is attached to the server 104.

The server 104 may have a crawler 127 that may create the server search index 126 and may, in some instances, create the remote service search index 130. In other instances, the remote service 110 may have a crawler 131 that may create a search index 132 that is provided at the remote service 110.

The embodiment 100 has been chosen to illustrate several possible configurations of a search system that includes a remote service. In a first configuration, a client device 102 may have a search engine 114 and crawler 115 that may crawl the remote data storage 112 and create a remote services index 122 that is stored on the client device 102. In such an embodiment, the crawler 115 may use a device based or user based authentication to access the remote service 110 and the remote service database 112. The first configuration may be used for remote services that are user specific as well as remote services that are shared between multiple users.

User based authentication may include any mechanism by which a specific user or group of users may be authenticated. User based authentication may include submitting a user name and password, swiping a user identification badge, performing a fingerprint identification, entering a personal identification number, or any other mechanism by which an individual user may be identified and authenticated. In some cases, a user based authentication may include authentication mechanisms for groups of people.

Device based authentication may include any mechanism by which a specific device or set of devices may be identified. For example, a specific computer may have a serial number, IP address, MAC address, or other hardware based unique identifier. In some cases, the firewall 106 may provide a degree of device based authentication as any device located behind the firewall 106 may be given access to a specific remote service 110.

The various authentication mechanisms may be used to limit or restrict access to a remote service 110 and the data storage 112. In some cases, like a remotely accessed email system, each user may be allocated a portion of the data storage 112 that may be accessed by that user but no other user. Such a system may use user based authentication.

In another case, a company-wide shared file system may be provided by a remote service 110. Such a remote service may permit any device having those specific Internet Protocol (IP) addresses assigned to the company to access the remote service 110.

In some cases, a combination of both device based and user based authentication may be used. For example, a remote service that provides accounting services may use device based authentication as an initial stage of authentication along with user based authentication to enable access to sensitive accounting data. In the example, device based authentication may enable a subset of the features or data to be available while a user based authentication may be used to access sensitive data or perform specific actions.

Embodiment 100 may be used to illustrate a second configuration. In the second configuration, a server 104 may perform a crawl of the remote service 110 to generate a remote service search index 130. The remote service search index 130 may be used by multiple users across a local area network to generate search results from the remote service 110. The second configuration may create a shared remote service search index that may span information that is viewable by several different users.

The second configuration may also be used for user-specific data. In such a use, the various search engines may perform a user-specific search of the remote service search index 130 that may return search results that apply to the user. In another use, the search engines may return general search results from the remote service search index 130 and may filter the results for a specific user.

A remote service 110 may be any type of service that is hosted and available over a network connection. Generally, remote services may be accessed through the Internet 108 by a client 102. In many cases, remote services may be private or at least have restricted access, and thereby are generally not accessible by internet search engines. Examples of such services may be remotely hosted email systems, a shared file service, various remotely hosted applications, and remotely hosted database systems. Examples of remotely hosted applications may include customer resource management systems, accounting systems, project management applications, and other applications.

Connections to the remote service 110 may be made using various encryption technologies, including a virtual private network, a secure internet connection, or other security measures. In some cases, the various crawlers 115 or 127 may be adapted to create an encrypted or secure connection with the remote service 110 while the crawler is active.

In many cases, a user may perform a search that incorporates results from a local data store 116, a server data store 124, a remote service data store 112, and an internet search engine 134. The results may be performed separately and aggregated together. In some cases, a single index may be created using the local index 118, the server index 126, and the remote service search index 122. In some cases, an internet search engine 134 may queried when a search engine runs to provide internet search results within the aggregated search results.

The internet search engine 134 may have an index 136 of the internet 108 and may also have a crawler 138 for generating and updating the index 136.

In some embodiments, the remote service 110 may have a crawler 131 that may create and maintain a search index 132. In some cases, a search engine may perform a query against the remote service search index 132 to return search results from the remote service 110. In other cases, the remote service search index 132 may be created at the remote service 110 and copied or synchronized with a remote service search index 122 at the client 102 or a remote service search index 130 at the server 104.

The server search engine 125 may be designed to return search results across a local area network in addition to remote services and the internet. In some cases, a local search engine 114 may perform a search of local data stores 116 while a search query is sent to the server search engine 125 for local area network search results. The results from both search engines may be aggregated together.

Search results may be aggregated in many different manners. In some cases, search results from the various data sources may be separated by data location, by file type, or by other sorting mechanisms. In some cases, the results from the various data sources, including remote services, may be aggregated together and sorted for relevance or some other factor.

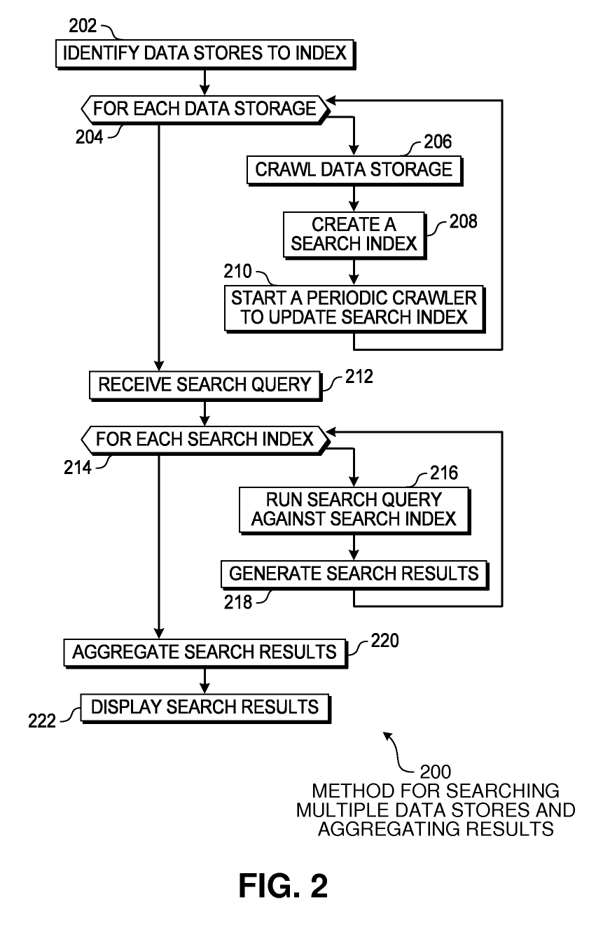

FIG. 2 is a flowchart illustration of an embodiment 200 showing a method for searching multiple data stores and aggregating results. Embodiment 200 is merely one method of indexing and searching multiple data stores including data stores on remote services.

Embodiment 200 creates separate indexes for each of the various data stores, runs queries using each index, and aggregates the result. Other embodiments may create a single index that includes the indexes of two or more data stores. For example, an index may be created that includes an index for local data as well as data from a remote service. Such an example may be useful in a situation such as when the remote service is an email service or some other personal or user-specific service.

In another example, an index may be created that includes an index for a local area network server data store and a remote service data store. Such an example may be useful when the remote service includes a shared file system that may be shared across multiple users.

Data stores are identified for indexing in block 202. The data stores may be any type of data store, including file systems, databases, or other data structures for which a search may be performed. For example, an accounting system database may be included as a searchable database to search customers, reports, invoices, and other elements within an accounting system.

In many cases, a database may be identified with appropriate permissions and authentication so that the database may be accessed. The permissions may include user based authentication mechanisms, device based authentication mechanisms, a combination of both user based and device based mechanisms as well as other authentication mechanisms.

For each data storage system in block 204, the data storage is crawled in block 206 to create a search index in block 208. After the initial search index is created in block 208, a periodic crawler may be started in block 210 to update the search index.

In some instances, a crawler may be used that is tailored to the type of data and manner in which the data are stored. For example, a file system crawler may be designed to traverse a hierarchical file system and collect file names and file content information from each file. In another example, a crawler for a remote service that provides a project management application may include mechanisms for connecting and authenticating with the remote service along with a programmatic interface to the project management database to query and interpret the data.

After the various indexes have been constructed, a search query may be received in block 212. For each search index in block 214, the search query is run against the index in block 216 to generate search results in block 218.

The search results may be aggregated in block 220 and displayed in block 222.

The search results may be aggregated and displayed in many different manners. In some embodiments, the search results may be aggregated, prioritized, and displayed in a list format with various levels of detail. In other embodiments, the search results may be separated by data store, by file type, or other category.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
indexing a remote service to produce a remote service index, said remote service having restricted data accessible from a client device;
storing said remote service index on an index host device;
receiving a search request on said client device;
performing a search using said remote service index and said search request to generate remote service search results; and
displaying said remote service search results.

2. The method of claim 1, said remote service being accessible with user-based authentication.

3. The method of claim 1, said remote service being at least one of a group composed of:
an email service;
a shared file service;
an application; and
a database system.

4. The method of claim 3, said application comprising at least one of a group composed of:
a customer resource management application;
a project management application; and
an accounting application.

5. The method of claim 1, said index host device being said client device.

6. The method of claim 1, said index host device being connected to said client device by a local area network.

7. The method of claim 1, said index host device being a server adapted to deliver said remote service.

8. The method of claim 1 further comprising:
indexing said client device to produce a client device index;
storing said client device search index on an index host device;
performing said search using said client device index and said search request to generate client search results; and
aggregating said client device search results with said remote service search results during said displaying said search results.

9. A computer readable medium comprising computer executable instructions adapted to perform the method of claim 1.

10. A system comprising:
a remote indexer adapted to index a remote service and generate a remote service index;
a search engine adapted to receive a search request, perform a remote service search using said remote service index, and return remote service search results; and
a display mechanism adapted to display said search results.

11. The system of claim 10, said remote service being accessible with user-based authentication.

12. The system of claim 10, said remote service being at least one of a group composed of:
an email service;
a shared file service;
an application; and
a database system.

13. The system of claim 12, said application comprising at least one of a group composed of:
a customer resource management application;
a project management application; and
an accounting application.

14. The system of claim 10, said remote service index being stored on a client device.

15. The system of claim 10, said remote service index being stored on an index host device, said index host being connected to a client device by a local area network.

16. A method comprising:
crawling a remote service to create a remote service index;
storing said remote service index in an index repository;
periodically updating said remote service index by crawling said remote service on a recurring basis;
receiving a search query from a client device;
generating remote service search results using said remote service index;
generating additional search results;
aggregating said remote service search results and said additional search results into aggregated search results; and
displaying said aggregated search results.

17. The method of claim 16, said additional search results comprising at least one of a group composed of:
client search results;
internet search results; and
local area network search results.

18. The method of claim 16, said remote service being accessible with user-based authentication.

19. The method of claim 16, said index repository being within said client device.

20. A computer readable medium comprising computer executable instructions adapted to perform the method of claim 16.
